(19) United States
(12) Patent Application Publication
(10) Pub. No.: US 2020/0406820 A1
(43) Pub. Date: Dec. 31, 2020

(54) ADAPTIVE BENDABLE MIRROR SYSTEM

(71) Applicant: GM GLOBAL TECHNOLOGY OPERATIONS LLC, Detroit, MI (US)

(72) Inventors: Alaeddin Bani Milhim, Ajax (CA); Akram M. Abdel-Rahman, Ajax (CA); Charles R. Quinn, Pleasant Ridge, MI (US)

(21) Appl. No.: 16/451,481

(22) Filed: Jun. 25, 2019

(51) Int. Cl. B60R 1/072; B60R 1/12

(52) U.S. Cl. CPC B60R 1/072; B60R 2001/1223; B60R 1/12

(57) ABSTRACT

A mirror assembly includes a housing. The assembly additionally includes a reflective body secured to the housing and having a rigid portion and a flexible portion. The assembly also includes an actuator operably coupled to the flexible portion. The actuator is configured to move the flexible portion between a first curvature relative to the rigid portion and a second curvature relative to the rigid portion. The assembly further includes a controller in communication with the actuator. The controller is configured to, in response to an operating condition being satisfied, control the actuator to move the flexible portion from the first curvature to the second curvature.

### INTRODUCTION

The present disclosure relates generally to a control system for an automotive side rearview mirror and, more particularly, to a rearview mirror control system for automatically adjusting the rear viewing angle of an automotive side rearview mirror to eliminate a blind spot during certain vehicle operating conditions.

Vehicle side rearview mirrors are oriented to provide the vehicle operator with a rear viewing zone behind and to the left and right of the vehicle to allow the vehicle operator to more safely operate the vehicle. However, when the vehicle is traveling around a corner, changing lanes, merging into a lane of traffic, etc., because the rear viewing zone is fixed there may be a blind spot in the rear viewing angle that may, in some situations, prevent the operator from seeing other vehicles.

### SUMMARY

A mirror assembly according to the present disclosure includes a housing. The assembly additionally includes a reflective body secured to the housing and having a rigid portion and a flexible portion. The assembly also includes an actuator operably coupled to the flexible portion. The actuator is configured to move the flexible portion between a first curvature relative to the rigid portion and a second curvature relative to the rigid portion. The assembly further includes a controller in communication with the actuator. The controller is configured to, in response to an operating condition being satisfied, control the actuator to move the flexible portion from the first curvature to the second curvature.

In various exemplary embodiments, the actuator comprises an SMA material or a piezoelectric element.

In an exemplary embodiment, the reflective body has an upper portion and a lower portion, and the flexible portion is provided at the lower portion.

In an exemplary embodiment, the reflective body has an inboard portion and an outboard portion, and the flexible portion is provided at the outboard portion.

According to various exemplary embodiments, the operating condition comprises a vehicle transmission being shifted into REVERSE, a vehicle turn being anticipated, or a vehicle turn being underway.

An automotive vehicle according to the present disclosure includes a body, a mirror housing secured to the body, and a flexible member having a reflective surface disposed in the mirror housing. The vehicle additionally includes an actuator operably coupled to the flexible member and configured to move a portion of the flexible member among a plurality of distinct curvatures. The vehicle further includes a controller in communication with the actuator. The controller is configured to, in response to an operating condition being satisfied, control the actuator to move the flexible portion among the plurality of distinct curvatures.

In an exemplary embodiment, the vehicle additionally includes a second mirror housing secured the body, a second flexible member having a second reflective surface disposed in the second mirror housing, and a second actuator operably coupled to the second flexible member and configured to move a portion of the second flexible member among a second plurality of distinct curvatures. The controller is in communication with the second actuator and configured to, in response to a second operating condition being satisfied, control the second actuator to move the second flexible portion among the second plurality of distinct curvatures.

In various exemplary embodiments, the actuator comprises an SMA material or a piezoelectric element.

In an exemplary embodiment, the vehicle additionally includes a transmission sensor in communication with the controller. The transmission sensor is configured to output a signal indicating a selected gear of a vehicle transmission. In such embodiments, the operating condition comprises a signal from the transmission sensor indicating the vehicle transmission being shifted into REVERSE.

In an exemplary embodiment, the vehicle additionally includes a hand-wheel angle sensor in communication with the controller. The hand-wheel angle sensor is configured to output a signal indicating a current position of a vehicle hand-wheel. In such embodiments, the operating condition comprises a signal from the hand-wheel angle sensor indicating a vehicle turn being underway.

In an exemplary embodiment, the vehicle additionally includes a geolocation sensor. The geolocation sensor is configured to output a current location of the vehicle. In such embodiments, the operating condition comprises a signal from the geolocation sensor indicating a vehicle turn being anticipated.

Embodiments according to the present disclosure provide a number of advantages. For example, the present disclosure provides a mirror with an increased field of view when needed, and moreover does so through only localized changes which do not impact the full field of view of the mirror.

The above advantage and other advantages and features of the present disclosure will be apparent from the following detailed description of the preferred embodiments when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a schematic plan view of a mirror assembly according to an embodiment of the present disclosure;

FIG. 2 is a schematic front view of a mirror assembly according to an embodiment of the present disclosure;

FIG. 3 is a flowchart representation of a method of controlling a mirror assembly according to an embodiment of the present disclosure; and

FIG. 4 is a schematic representation of a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Known devices for adjusting field of view of a mirror of an automotive vehicle involve moving the whole reflective surface of the mirror. However, such devices must trade off visibility in one area for visibility in another area. Consequently, moving such mirrors to increase visibility in a blind spot results in a corresponding reduction in visibility in another region. Such an outcome may be undesirable for some operators.

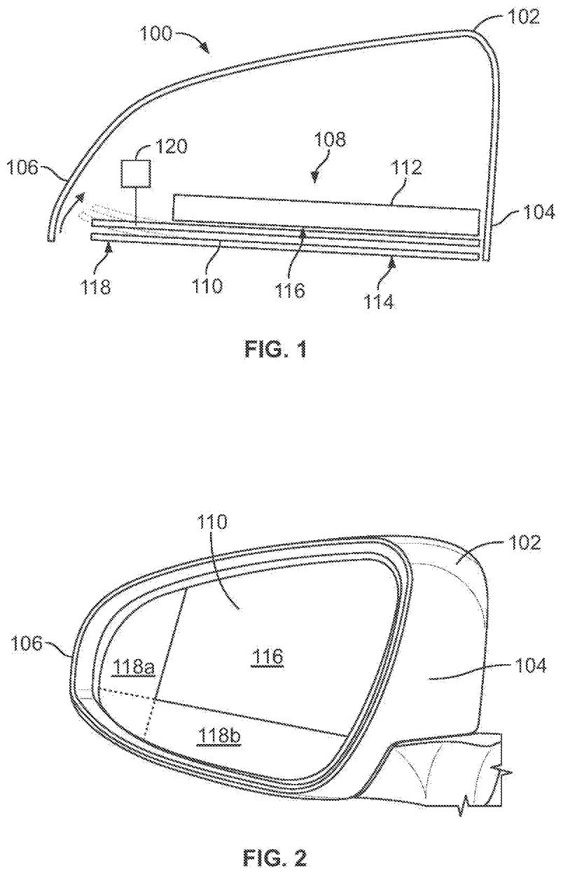

Referring now to FIG. 1, a schematic plan view of a mirror assembly 100 is illustrated. The mirror assembly 100 includes a housing 102 having an inboard portion 104 and an outboard portion 106. The inboard portion 104 is configured to couple to an external portion of a vehicle body, e.g. proximate an A pillar of the body, as will be discussed in further detail below.

The mirror assembly 100 additionally includes a reflective element 108. The reflective element 108 is provided with one or more flexible layers 110 and a rigid member 112. The flexible layer(s) 110 are provided with a reflective layer 114. The reflective layer 114 may be provided on an outermost surface of the flexible layer(s) 110, sandwiched within the flexible layer(s) 110, or configured otherwise as appropriate. The reflective layer 114 is arranged to reflect images from the exterior of the reflective element 108.

The flexible layer(s) 110 may be formed of any relatively flexible material capable of being provided with the reflective layer. As a nonlimiting example, the flexible layer may be a film comprising polyester, polycarbonate, or polyethylene. Other examples include, but are not limited to, thermoplastic polymers such as ABS (Acrylonitrile Butadiene Styrene) or acrylic. The reflective layer 114 may be secured to the flexible layer(s) 110 via any suitable method, such as chrome plating or vacuum metallization. In some embodiments, one or more additional layers having anti-corrosive and/or anti-abrasive properties may be superposed over the flexible layer(s) 110.

The flexible layer(s) 110 are secured to the rigid member 112 at a fixed portion 116. At the fixed portion 116 the flexible layer(s) 110 is maintained generally rigid by being secured to the rigid member 112. The flexible layer(s) 110 also has at least one free portion 118 which is not secured to the rigid member 112. The free portion 118 is thereby able to flex relative to the fixed portion 116, as will be discussed in further detail below.

The rigid member 112 may be provided as a backer to the flexible layer(s) 110 as illustrated in FIG. 1, integrated into a portion of the flexible layer(s) 110, or otherwise coupled to the flexible layer(s) 110 to provide rigidity at the fixed portion 116.

At least one actuator 120 is coupled to the free portion 118. The actuator 120 is configured to selectively apply force to the free portion 118 and thereby flex the free portion 118 relative to the fixed portion 116. In an exemplary embodiment, the free portion 118 has a nominal position in which the reflective layer 114 forms a generally planar reflective surface across the free portion 118. The actuator 120 is configured to selectively deflect the free portion 118 away from the nominal position. In an exemplary embodiment, the actuator 120 is configured to selectively deflect the free portion 118 toward the interior of the housing 102, thereby forming a local convex surface in the reflective layer 114 at the free portion 118. In an exemplary embodiment, the actuator 120 is configured to selectively deflect the free portion 118 to form an approximately 300 mm radius of curvature at the outboard edge.

In an exemplary embodiment the actuator 120 comprises a smart material such as a shape memory alloy (SMA) actuator. In a second exemplary embodiment, the actuator 120 comprises a piezoelectric material. In other embodiments, other actuator types may be used as appropriate.

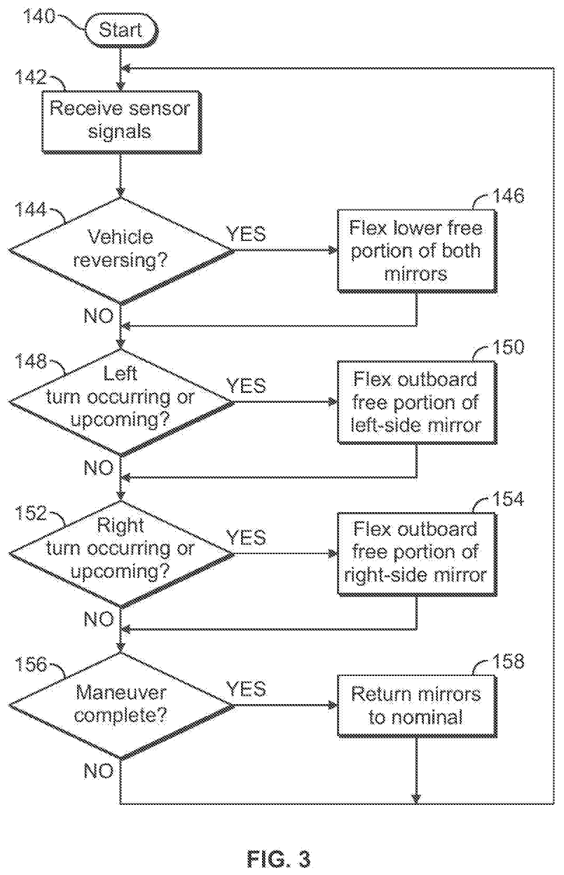

Referring now to FIG. 2, a front view of the mirror assembly 100 is illustrated schematically. In this illustrated embodiment, the fixed portion 116 is provided generally proximate the inboard portion 104 and at an upper portion of the housing 102. In the illustrated embodiment, the free portion 118 comprises an outboard free portion 118a, disposed proximate the outboard portion 106 of the housing 102, and a lower free portion 118b, disposed at a lower portion of the housing 102. A first actuator 120 may be associated with the outboard free portion 118a, and a second actuator 120 may be associated with the lower free portion 118b. Advantageously, an outboard convex surface may be formed by flexing the outboard free portion 118a, thereby increasing a field of view at the outboard periphery of the mirror assembly 100, and a lower convex surface may be formed by flexing the lower free portion 118b, thereby increasing a field of view at the lower periphery of the mirror assembly 100.

Referring now to FIG. 3, a method of controlling the mirror assembly 100 is illustrated in flowchart form. In particular, the method of FIG. 3 illustrates control of a first, left-side mirror assembly and a second, right-side mirror assembly. The method begins at block 140.

Sensor signals are received, as illustrated at block 142. In an exemplary embodiment, the sensor signals include a current vehicle speed, a current vehicle hand-wheel position, a current transmission gear, a current geolocation, and one or more processed optical camera feed. However, in other embodiments additional sensor signals or other sensor signals may be used.

A determination is made of whether the vehicle is currently reversing, as illustrated at operation 144. In an exemplary embodiment, this determination is based on a signal indicative of a current transmission gear, and may be satisfied when the signal indicates that the transmission is in REVERSE.

In response to the determination of operation 144 being positive, the lower free portion of both mirror assemblies is flexed, as illustrated at block 146. Convex portions are thereby formed at the lower portions of reflective surfaces of both mirrors. Range of view at a lower portion of the mirror, e.g. proximate the rear wheels, is thereby increased. Control then proceeds to operation 148. Likewise, in response to a negative determination of operation 144, control proceeds to operation 148.

A determination is made of whether a left turn is occurring or upcoming, as illustrated at operation 148. In an exemplary embodiment, this determination may be satisfied in response to a sensor signal for the current hand-wheel position indicating that a left turn is underway, or based on the current geolocation and/or processed optical camera feed indicating that the vehicle is approaching a leftward curve or merge in a road.

In response to the determination of operation 148 being positive, the outboard free portion of the left-hand mirror assembly is flexed, as illustrated at block 150. A convex portion is thereby formed at the outboard portions of the reflective surface of the left-hand mirror. Range of view at the outboard portion of the mirror, e.g. at a blind spot on the leftward side of the vehicle, is thereby increased. Control then proceeds to operation 152. Likewise, in response to a negative determination of operation 148, control proceeds to operation 152.

A determination is made of whether a right turn is occurring or upcoming, as illustrated at operation 152. In an exemplary embodiment, this determination may be satisfied in response to a sensor signal for the current hand-wheel position indicating that a right turn is underway, or based on the current geolocation and/or processed optical camera feed indicating that the vehicle is approaching a rightward curve or merge in a road.

In response to the determination of operation 152 being positive, the outboard free portion of the left-hand mirror assembly is flexed, as illustrated at block 154. A convex portion is thereby formed at the outboard portions of the reflective surface of the left-hand mirror. Range of view at the outboard portion of the mirror, e.g. at a blind spot on the leftward side of the vehicle, is thereby increased. Control then proceeds to operation 156. Likewise, in response to a negative determination of operation 152, control proceeds to operation 156.

A determination is made of whether a reverse or turning maneuver is complete, as illustrated at operation 156. In an exemplary embodiment, this determination is satisfied in response to a vehicle transmission being shifted out of REVERSE and/or a vehicle hand-wheel being returned to a nominal position at the end of a turning maneuver.

In response to the determination of operation 156 being satisfied, the mirrors are returned to a nominal position, e.g. by discontinuing any flexion applied to free portions of the mirror assemblies. Control then returns to block 142. Likewise, in response to a negative determination of operation 156, control returns to block 142.

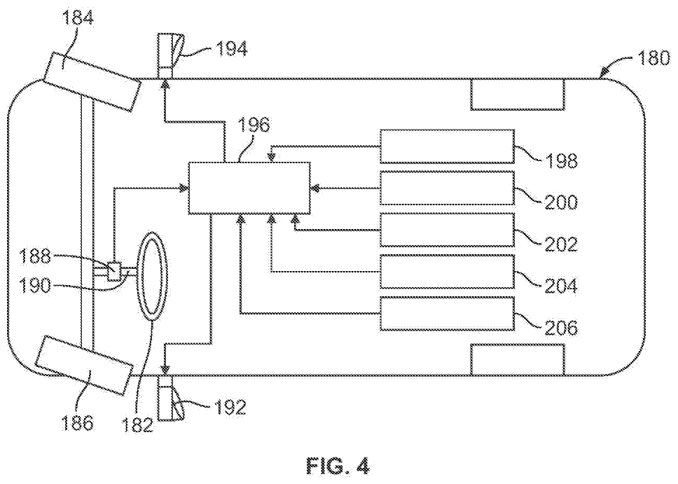

Referring to FIG. 4, a schematic view of a vehicle 180 is shown. The vehicle 180 includes a vehicle hand-wheel 182 for steering front wheels 184 and 186 of the vehicle 180. A hand-wheel angle sensor 188 is coupled to a column 190 that is rotated when the hand-wheel 182 is rotated to turn the wheels 184 and 186, where the hand-wheel angle sensor 188 provides a signal indicative of the rotation. The vehicle 180 includes a driver side rearview mirror 192 disposed on a first side of the vehicle body and a passenger side rearview mirror 194 on a second side of the vehicle body. In an exemplary embodiment, the driver side rearview mirror 192 are each arranged in a similar fashion as the mirror assembly 100 illustrated in FIGS. 1 and 2. The rearview mirrors 192 and 194 may be pivoted to eliminate potential blind spots during lane changing, merging, turning, etc., as discussed above. A rearview mirror control system 196 automatically controls the position of the mirrors 192 and 194 during these vehicle operation conditions.

The rearview mirror control system 196 receives vehicle operation information from a plurality of sensors. In the illustrated embodiment the plurality of sensors includes a vehicle speed sensor 198, a transmission sensor 200, an optical camera 202, an output of a geolocation receiver 204, e.g. a GPS receiver, and digital map information 206. Further, the rearview mirror control system 196 receives the hand-wheel angle signal from the hand-wheel angle sensor 188. The inputs to the rearview mirror control system 196 discussed above are available from known vehicle sensors and systems used for other vehicle systems, such as vehicle stability and enhancement systems. The plurality of sensors may include other sensors in addition to, or in place of, the exemplary sensors discussed above, as will be apparent to those skilled in the art.

The rearview mirror control system 196 uses the sensor signals to determine if and when the rear viewing zone of the rearview mirrors 192 and 194 need to be changed, consistent with the discussion above, to eliminate a potential blind spot. For example, if the rearview mirror control system 196 determines from map information and/or GPS information that a turn in the road is coming up, or a lane merge is coming up, etc., the rearview mirror control system 196 will adjust the appropriate rear viewing zone of the mirror 192 or 194 before the event occurs to eliminate the potential blind spot. Likewise, if the vehicle operator turns on the turn signal or begins a turn for a lane change, lane merge, etc., the rearview mirror control system 196 can adjust the rear viewing zone of the mirror 192 or 194 accordingly to eliminate the potential blind spot. Further, the rearview mirror control system 196 can use the hand-wheel angle signal and the vehicle speed signal to determine the appropriate position of the mirrors 192 and 194 for banked turns.

The discussion above describes changing the rear viewing zones of the mirrors 192 and 194 from a normal rear viewing position to a modified rear viewing position, and then back again. However, in an alternate embodiment, the rearview mirror control system 196 can selectively change the rear viewing angle of the mirrors 192 and 194 continuously over a range of angles or at several discreet rear viewing positions depending on the vehicle driving condition. The rearview mirror control system 196 can use a simple algorithm that adjusts the viewing angle of the mirrors 192 and 194 from a normal rear viewing zone to a modified rear viewing zone based on only a few inputs. Alternately, the rear view mirror control system 196 can employ a sophisticated algorithm that changes the rear viewing zones of the mirrors 192 and 194 over a predetermined range based on many inputs for the various sensors discussed above.

As may be seen, embodiments according to the present disclosure may provide increased field of view when needed, and moreover may do so through only localized changes which do not impact the full field of view of the mirror.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A mirror assembly comprising:
a housing;
a reflective body secured to the housing and having a rigid portion and a flexible portion;
an actuator operably coupled to the flexible portion and configured to move the flexible portion between a first curvature relative to the rigid portion and a second curvature relative to the rigid portion; and
a controller in communication with the actuator, the controller being configured to, in response to an operating condition being satisfied, control the actuator to move the flexible portion from the first curvature to the second curvature.

2. The assembly of claim 1, wherein the actuator comprises an SMA material.

3. The assembly of claim 1, wherein the actuator comprises a piezoelectric element.

4. The assembly of claim 1, wherein the reflective body has an upper portion and a lower portion, and wherein the flexible portion is provided at the lower portion.

5. The assembly of claim 1, wherein the reflective body has an inboard portion and an outboard portion, and wherein the flexible portion is provided at the outboard portion.

6. The assembly of claim 1, wherein the operating condition comprises a vehicle transmission being shifted into REVERSE.

7. The assembly of claim 1, wherein the operating condition comprises a vehicle turn being anticipated.

8. The assembly of claim 1, wherein the operating condition comprises a vehicle turn being underway.

9. An automotive vehicle comprising:
a body;
a mirror housing secured to the body;
a flexible member having a reflective surface, the flexible member being disposed in the mirror housing;
an actuator operably coupled to the flexible member and configured to move a portion of the flexible member among a plurality of distinct curvatures; and
a controller in communication with the actuator, the controller being configured to, in response to an operating condition being satisfied, control the actuator to move the flexible portion among the plurality of distinct curvatures.

10. The automotive vehicle of claim 9, further comprising a second mirror housing secured the body;
a second flexible member having a second reflective surface, the second flexible member being disposed in the second mirror housing; and
a second actuator operably coupled to the second flexible member and configured to move a portion of the second flexible member among a second plurality of distinct curvatures;
wherein the controller is in communication with the second actuator and configured to, in response to a second operating condition being satisfied, control the second actuator to move the second flexible portion among the second plurality of distinct curvatures.

11. The automotive vehicle of claim 9, wherein the actuator comprises an SMA material.

12. The automotive vehicle of claim 9, wherein the actuator comprises a piezoelectric element.

13. The automotive vehicle of claim 9, further comprising a transmission sensor in communication with the controller, the transmission sensor being configured to output a signal indicating a selected gear of a vehicle transmission, wherein the operating condition comprises a signal from the transmission sensor indicating the vehicle transmission being shifted into REVERSE.

14. The automotive vehicle of claim 9, further comprising a hand-wheel angle sensor in communication with the controller, the hand-wheel angle sensor being configured to output a signal indicating a current position of a vehicle hand-wheel, wherein the operating condition comprises a signal from the hand-wheel angle sensor indicating a vehicle turn being underway.

15. The automotive vehicle of claim 9, further comprising a geolocation sensor in communication with the controller, the geolocation sensor being configured to output a current location of the vehicle, wherein the operating condition comprises a signal from the geolocation sensor indicating a vehicle turn being anticipated.
